(19) United States
(12) Patent Application Publication
(10) Pub. No.: US 2026/0060189 A1
(43) Pub. Date: Mar. 5, 2026

(54) MODULAR POTTING SYSTEM AND METHOD

(71) Applicant: Byron TURNER, Cottage Grove, OR (US)

(72) Inventor: Byron TURNER, Cottage Grove, OR (US)

(21) Appl. No.: 18/821,819

(22) Filed: Aug. 30, 2024

(51) Int. Cl. A01G 27/00; A01G 9/02

(52) U.S. Cl. CPC A01G 27/008; A01G 9/023; A01G 9/024

(57) ABSTRACT

A modular potting system includes a rigid base unit with one or more modules; at least one interchangeable plant node container, the interchangeable plant node container having an iris control lever, and a locking ring; and an internal irrigation system having a spiral drip emitter tube positioned throughout the rigid base unit, an upper water inlet, a base drip emitter tube positioned at the base of the rigid base unit, a base water inlet, and at least a water outlet.

### TECHNICAL FIELD

The embodiments described herein are generally directed to a modular potting system and method in small farming operations and gardening contexts, and, more particularly, to a modular potting system and method.

### BACKGROUND

Globally, populations continue to drift toward urban and suburban living. Simultaneously, desertification, aquifer depletion, pollution and a rising need mining and other land destroying processes needed to supply a growing population is making arable land a vanishing resource. Economic constraints also mean that housing is more concentrated, with smaller yards and more multifamily units. Another economic factor is that gardening for food is not just an interest, but a necessity for some. In urban and suburban situations, growing plants above ground is one and, for some, the only option. Existing methods include pots or bags that either rest on the ground or hang from structures. These containers can hold one or more plants, but require more regular water than growing plants in the ground. This is especially true for pots or bags hanging from structures that shield them from rain.

For those growing food, maximum volume is the goal. A popular option is fabric bags and pots that allow for the growth of multiple plants. There are two basic types: bags with multiple openings and flaps to hold the dirt in, but which can be moved to allow seedlings to be inserted; and fabric planters that hang on a wall or from the top of a fence which can accommodate plants in envelope-like containers which hold a small amount of soil and one plant in each envelope. These fabric containers dry out quickly, both because of the limited amount of soil and the permeability of the fabric. The major problem with the fabric, multi-plant style of pot is getting the plants inside them. Only the top space can host plants grown from seed. Plants for the other holes must be started in small containers which can often severely constrain the roots. Gardeners then transfer these delicate starts to the pot. Plant roots must be pushed through the flaps holding the soil in place. This is very difficult if the bag already has soil. If not, soil must be poured over the exposed roots. Either way, root damage is inevitable.

Furthermore, window boxes, and planters designed to mimic a window box, are another option, but this frequently means plants are located in the shadow of a house (or fence). This can also lead to water damage to the structure if either the water is not carefully applied, or the material is permeable. Watering window box style pots can mean running a hose or bringing out a watering can regularly. For the others, hydrodynamics dictates that gravity will pull the water downward, but it will find or make a channel and all the water will tend in that direction as the easiest path. Thus, water in the multiple plant hanging pot may just run out of one of the holes, and in the case of the envelope style wall hanger, watering the top envelope doesn't necessarily lead to the envelopes beneath getting water as the path of least resistance is as likely to be out the side or front, thus there is no choice but to water each cell individually and frequently. All of the conventional means available to help gardeners take advantage of vertical space have one more inescapable problem: watering pots is somewhere between inconvenient and extremely difficult.

Accordingly, a modular potting system and method would offer many benefits such as an internal watering system which guarantees water and nutrients reach the roots of plants; removable modules that serve as seed starters that can be placed in the pot, protecting roots from damage; interconnect-ability so that all pots in the system are watered from a single source on a timer for set and forget convenience; and compatibility with standard methods for delivering water, such as garden hose and drip irrigation. As such, a standard liquid fertilizer distribution unit can be utilized promoting maximum food production. A modular potting system and method is focused on gardening purposes but would be scalable for use in commercial food production and other uses.

### SUMMARY

In an embodiment, a modular potting system, comprising: a rigid base unit with one or more modules; at least one interchangeable plant node container configured to fit in the module, the interchangeable plant node container having an iris control lever, and a locking ring configured to secure the interchangeable plant node container to the module; and an internal irrigation system having a spiral drip main line positioned throughout the rigid base unit configured to irrigate the interchangeable plant node container, an upper water inlet configured to feed water to the spiral drip main line, a base drip emitter tube positioned at the base of the rigid base unit configured to irrigate the interchangeable plant node container, a base water inlet configured to feed water to the base drip emitter tube, and at least a water outlet configured to allow a controlled release of water, wherein the spiral drip main line and the base drip emitter tube are connected to the water outlet.

In an embodiment, an irrigation system for pot modules, the irrigation system comprises: one or more modular potting system configured to be daisy-chained to each other, the modular potting system having a rigid base unit configured to contain one or more pot modules, at least one interchangeable plant node container configured to fit in the pot modules, the interchangeable plant node container including an iris control lever, and a locking ring configured to secure the interchangeable plant node container to the pot module; a spiral drip main line positioned throughout the rigid base unit configured to irrigate the interchangeable plant node containers; an upper water inlet configured to feed water to the spiral drip main line; a base drip emitter tube positioned at the base of the rigid base unit configured to irrigate the interchangeable plant node containers; a base water inlet configured to feed water to the base drip emitter tube; and at least a water outlet configured to allow a controlled release of water, wherein the spiral drip main line and the base drip emitter tube are connected.

In an embodiment, a modular potting method, the method comprises: providing a rigid base unit having one or more modules; inserting at least one interchangeable plant node container into the module, the interchangeable plant node container comprising an iris control lever, and a locking ring configured to secure the interchangeable plant node container to the module; and irrigating the interchangeable plant node container with an internal irrigation system, the internal irrigation system comprising a spiral drip main line positioned throughout the rigid base unit, an upper water inlet configured to feed water to the spiral drip main line, a base drip emitter tube positioned at the base of the rigid base unit, a base water inlet configured to feed water to the base drip emitter tube, and at least a water outlet configured to allow a controlled release of water, wherein the spiral drip main line and the base drip emitter tube are connected to the water outlet.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a modular potting system with an internal irrigation system, according to an embodiment;

FIG. 2 illustrates an interchangeable plant node container, according to an embodiment;

FIG. 3 illustrates a modular potting system connected to another modular potting system, according to an embodiment; and

FIG. 4 illustrates a modular potting method process; according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments.

However, it will be apparent to those skilled in the art that embodiments of the invention can be practiced without these specific details. In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

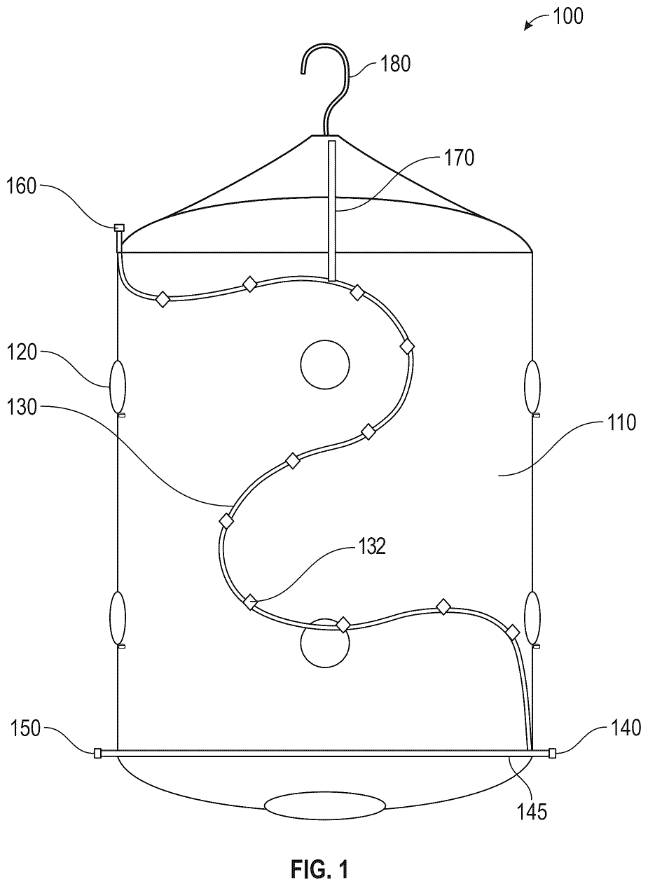

FIG. 1 illustrates a modular potting system 100 with an internal irrigation system, according to an embodiment. Modular potting system 100 comprises a rigid base unit 110, which may include modules 120 holding interchangeable plant node containers 200, a drip main line 130 with drip holes 132 to irrigate modular potting system 100 with an upper water inlet 160 configured to receive liquid from the top and an outlet flow 150, and a base water inlet 140 that feeds liquid (water) to base drip emitter tube 145. Although only one or two of each component is illustrated, it should be understood that modular potting system 100 may comprise any number of each component, including a plurality of one or more components. Modular potting system 100 may be connected to or integrated into an external irrigation system or water source that allows base water inlet 140 or upper water inlet 160, which controls (e.g., allows water to flow) the passage of liquid to the emitter tubes (drip main line 130 and/or base drip emitter tube 145) into outlet flow 150.

Modular potting system 100 is configured to streamline and enhance the process of planting and growing plants, offering versatility and efficiency for gardeners. Modular potting system 100 allows for customization in terms of spacing, plant density, and arrangement, making module potting system 100 a better option to optimize space and resource use in various growing environments that are limited in space or soil. Additionally, modular potting system features an internal irrigation system that allows easy accommodations for watering and to move, making them perfect for urban gardening, greenhouses, or indoor plant care.

Rigid base unit 110 provides structural stability, ensuring that modular potting system 100 supports the weight of the plant and soil without tipping over. Additionally, rigid base unit 110 features drainage holes and/or channels to prevent waterlogging and root rot by allowing excess water to escape. In the present invention, rigid base unit 110 may include modules 120. Each module 120 may be independently configured or rearranged, allowing for customizable plant arrangements and spacing according to the needs of different plant species or growth stages. Further, modules 120 hold an interchangeable plant node container 200. Module's 120 flexibility in sizes and shapes help optimize space usage and may accommodate various growing conditions.

Drip main line 130 facilitates consistent and efficient water delivery to each module 120 in modular potting system 100. Drip main line 130 may have a spiral-type structure that allows water to be distributed throughout modular potting system 100. For example, if modular potting system is cylindrical, a spiral-type structure allows for drip main line 130 to reach all modules 120. However, it should be understood that drip main line 130 includes any shape that provides a systematic way to distribute water evenly across modules 120, reducing the need for manual watering and minimizing the risk of over-or under-watering. Drip main line 130 may be connected to external irrigation systems that supply water directly to drip main line 130 and manage excess water through water outlet 160 which may further be connected to a separate system (e.g. another modular potting system 100) and transfer the excess water to said system.

Drip holes 132 facilitate precise and efficient watering throughout modular potting system 100. The distribution of water through drip holes 132 minimizes the risk of overwatering and water runoff, which may lead to nutrient leaching and soil erosion. Drip holes 132 may be strategically placed along drip main line 130 to release water in small, controlled amounts directly to modules 120. For example, this targeted watering method via drip holes 132 facilitates a steady, gentle supply of moisture, which helps maintain consistent soil hydration and reduces water wastage while modular potting system 100 is hanging from rigid base unit 110. Furthermore, drip main line 130 may be fed through upper water inlet 160 to facilitate water fed through the upper zone of the system and allow a more aesthetic design. As an example, modular potting system 100 may include a detachable hook 180 with hanger support cables that allow modular potting system 100. Here, detachable hook 180 supports the weight of modular potting system 100 while also allowing upper water inlet 160 feed water into drip main line 130 and hiding the connection to an external water source.

Base drip emitter tube 145 may be fed by base water inlet 140 and deliver water directly to the base of modular potting system 100. Base drip emitter tube 145 may be positioned at modular potting system's 100 base zone to ensure a consistent and controlled flow of water to the base zone, minimizing waste and promoting efficient use of resources. For example, having base drip emitter tube 145 facilitates a steady, gentle supply of moisture to modules 120 at the base zone, which helps maintain consistent soil hydration and reduces water wastage while modular potting system 100 is resting in a surface. Excess water may be drained via water outlet 150.

Rigid sprinkler base 170 may be connected to drip main line 130 or any water inlet in modular potting system 100 and evenly distribute water over a large area from the top of modular potting system. By spraying water in a wide, controlled pattern, modular potting system 170 may reach various parts of an area and distribute adequate moisture, promoting uniform growth and preventing dry spots. Rigid sprinkler base 170 may be adjusted to cover different areas and water levels, allowing for flexibility in irrigation practices across diverse landscapes.

Overall, modular potting system 100 comprise an internal irrigation system as well as decorative water features. Modular potting system 100 may be placed on the ground and daisy chained with another modular potting system 100 or a standard garden hose or drip tubing.

Modular potting system 100 may serve gardens with limited space and vertical designs by proving pots that allow them to plant in the top, sides and bottom of the pot and moisture is maintained with an internal irrigation system that includes drip main line 130. Modular potting system 100 may connect directly to an external irrigation system and/or to another modular potting system 100 proving a single, automated water distribution system that provides set and forget ease and the assurance that their plants maintain the right amount of moisture regardless climatic conditions. Modular potting system 100 is a unique addition to the home gardening space.

Further, seeds in interchangeable plant node container 200 may start in 2.5 inch×3 inch and when the plants are mature enough, iris control lever 220 may be adjusted to secure the plants. Then a seed starter/planter insert may be inserted into interchangeable plant node container 200 and locking ring 220 may be turned clockwise to secure the seed starter/planter insert in place. For aesthetic reasons, modular potting system 100 may be watered through a ¼ inch drip line which may be hidden behind detachable hook 180. Drip main line 130 may be attached to whatever structure modular potting system 100 hangs from, thus a single water source may be used to water as many modular potting systems 100 as the user wants to hang.

Modular potting system 100 may uniquely serve gardeners by proving modules 120 that allow them to plant in the top, sides and bottom of the pot and moisture is maintained with an internal irrigation system.

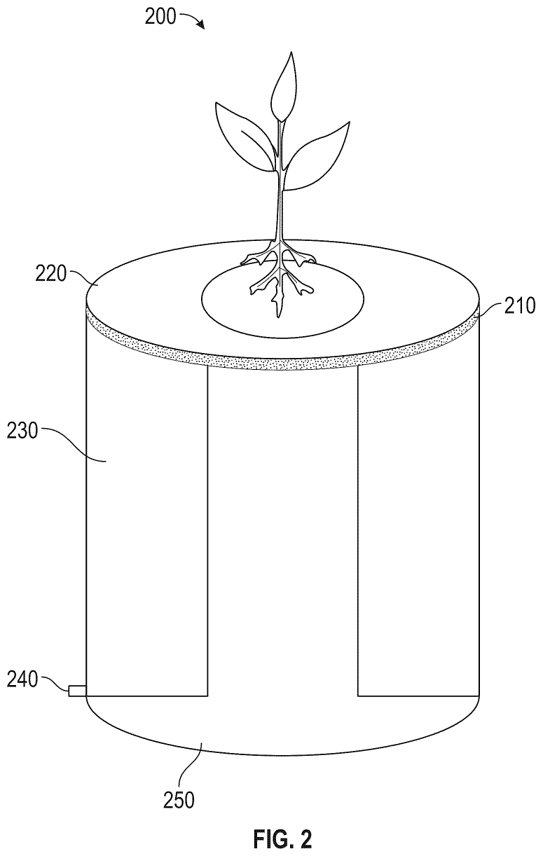

FIG. 2 illustrates an interchangeable plant node container 200, according to an embodiment. Interchangeable plant node 200 comprises a locking ring 210, and an iris control lever 220. Further, interchangeable plant node comprises a slat 230, a lower iris control lever 240, and a lower iris opening 250. As previously mentioned, interchangeable plant node container 200 may be a specialized vessel designed to support and enhance the growth of plant nodes, often used in hydroponic or aeroponic systems such as modular potting system 100. Interchangeable plant node's 200 primary function is to provide a controlled environment where plant nodes may develop roots and shoots efficiently. Interchangeable plant node 200 features a structure that allows for optimal nutrient delivery, adequate airflow, and proper drainage, which are essential for healthy plant development. Further, Interchangeable plant node 200 facilitates the propagation and cultivation of plants by supporting the plant nodes in an ideal growth medium.

Locking ring 210 in interchangeable plant node container 200 helps maintaining the stability and structure of the plant's internal components. Locking ring 210 is configured to fit in modules 120. Further, locking ring's 210 structure helps secure the arrangement of vascular tissues, such as xylem and phloem, within the plant node in interchangeable plant node container 200, ensuring that they remain properly aligned for efficient nutrient and water transport. By stabilizing these tissues, locking ring 210 may also support the overall strength and rigidity of the plant stem, contributing to its ability to withstand mechanical stresses and environmental forces such as gravity when modular potting system 100 is in a hanging position. Additionally, locking ring 210 regulates the growth pattern of the plant by providing structural support that allows for proper leaf and branch arrangement, optimizing photosynthesis and overall plant health.

Iris control lever 220 controls the diameter of the aperture, which may regulate the amount of light entering the plant or the size of the aperture. The adjustment capability of iris control lever 220 may significantly impact the appropriate amount of light or air exposure based on its specific needs, allowing for either a broader exposure to the surrounding environment or a more protection from nature elements. This may help in maintaining optimal soil moisture levels, prevent overwatering or underwatering, and ultimately supports healthy plant growth. Additionally, iris control lever 220 may be paired with automated or semi-automated watering systems such as the present invention to offer a precise way to manage plant care.

The mechanism behind iris control lever 220 may involve a series of overlapping blades or leaves within each other in iris control lever 220. Iris control lever's 220 blades may adjust in unison to form a circular or nearly circular opening, with the lever's position determining the aperture size for the plant to come out. A larger aperture, created by moving iris control lever 220 in one direction, lets more light and air through. Conversely, a smaller aperture, achieved by moving iris control lever 220 in the opposite direction, restricts light and air to the plant. This precise control allows interchangeable plant node container 200 to control the different shapes and sizes to provide optimal conditions for plant growth. Finally, iris control lever 220 may be made of plastic or any suitable material that allows iris control lever 220 movement and is compatible with interchangeable plant node container 200.

Slat 230 may be any structure involved in supporting or organizing plant tissues within plant node container 200. Moreover, slat 230 may function as a supportive element that helps maintain the structural integrity of plant node container 200 in modular potting system 100. Slat 230 may assist in the arrangement and anchoring of vascular tissues, such as xylem and phloem, thereby ensuring proper nutrient and water transport. Additionally, slat 230 helps in organizing the growth of leaves, branches, or flowers that emerge from the node of the plant, thereby contributing to the overall stability and functionality of the plant. Finally, slat 230 may have moisture absorption properties to keep water available for the plant for longer periods of time.

Similar to iris control lever 220, lower iris control lever 240 may function as a mechanism for regulating the water flow to the plant in interchangeable plant node container 200. Lower iris control lever 240 allows interchangeable plant node container 200 to control the amount of water dispensed to the plant's roots. By adjusting the lever, lower iris control lever 240 may open or close lower iris opening 150 to fine-tune the irrigation process and water delivered via drip main line 130 or base drip emitter tube 145, ensuring the plant receives the appropriate amount of water based on its specific needs. Lower iris control lever 240 features help maintain an optimal soil moisture level, prevent overwatering or underwatering, and ultimately supports healthy plant growth.

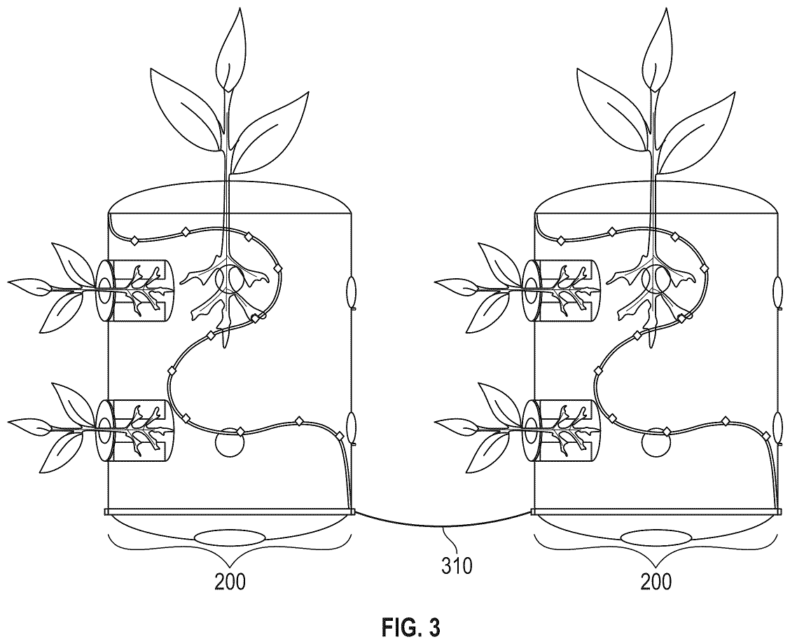

FIG. 3 illustrates a modular potting system 100 connected to another modular potting system 100, according to an embodiment. In this embodiment, modular potting system 100 may be connected via connection 310 to another modular potting system 100 or external irrigation system Connection 310 may be any connection that may accomplish a daisy-chained structure or system. Daisy-chaining at least two modular potting systems 100 in an irrigation system involves connecting the modular potting systems 100 to streamline water distribution. The process starts by setting up connection 310 for a first modular potting system 100, which is connected to a water source inlet. The water source inlet may be base water inlet 140 or upper water inlet 160. Water is delivered to modular potting system 100, and any excess or runoff is channeled through water outlet 150 to another modular potting system 100. This setup ensures that both modular potting systems 100 receive water efficiently and consistently.

In this arrangement, first modular potting system 100 pot acts as the primary recipient of water, and second modular potting system 100 relies on the excess water that flows through connection 310. Modular potting system 100 connected to another modular potting system 100 may help simplify irrigation by consolidating the watering process for multiple modular potting systems 100 and may ensure that water usage is optimized across both modular potting systems 100.

Connection 310, from which daisy chaining is accomplished in irrigation modular potting system 100 offers several benefits, including efficient water use and simplified management. By connecting modular potting system 100 in series, excess water from the first modular potting system 100 is redirected to the second, ensuring both receive adequate moisture without the need for separate irrigation setups. This method reduces water wastage, as it minimizes runoff and evaporation by utilizing all available water. Additionally, modular potting system 100 connected to another modular potting system 100 promotes balanced soil moisture across both modular potting system 100, which supports healthier plant growth and reduces the risk of issues like root rot or drought stress.

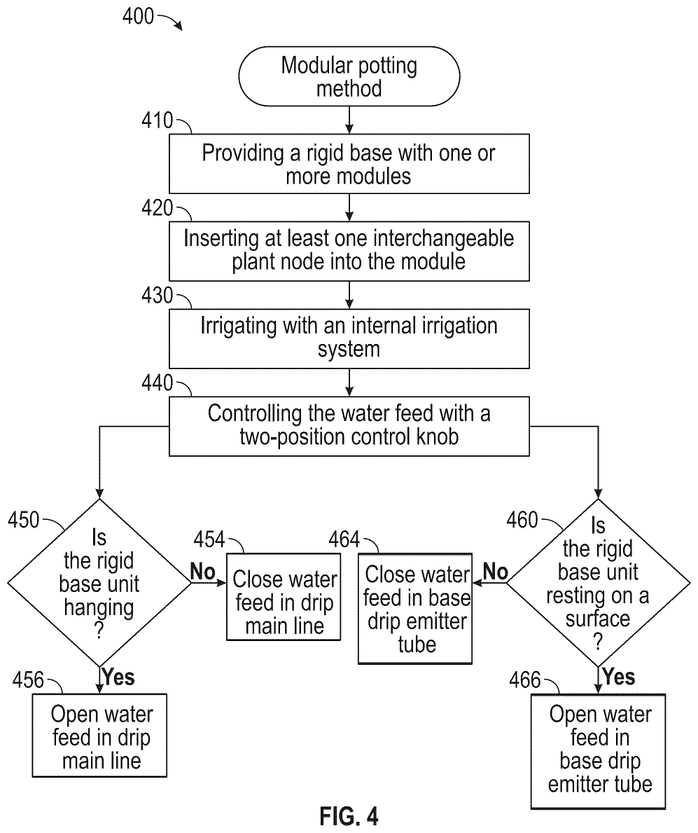

FIG. 4 illustrates a modular potting method process 400, according to an embodiment. Modular potting method process 400 may be implemented with the assistance an internal irrigation system. Process 400 includes providing a rigid base unit 110 and inserting at least one interchangeable plant node container 200 into module 120. Further, interchangeable plant node container 200 comprises an iris control lever 220, and a locking ring 210 configured to secure interchangeable plant node container 200 to module 120. Additionally, process 400 may comprise irrigating interchangeable plant node container 200 with an internal irrigation system, the internal irrigation system comprising a drip main line 130 which may be shapes as a spiral drip emitter tube positioned throughout rigid base unit 110. Process 400 further comprises an upper water inlet 160 configured to feed water to drip main line 130, a base drip emitter tube 145 positioned at the base of rigid base unit 110, a base water inlet 140 configured to feed water to base drip emitter tube 145, and at least a water outlet 150 configured to allow a controlled release of water, wherein drip main line 130 and base drip emitter tube 145 are connected to the water outlet.

In modular potting system subprocess 410, modular potting system 200 provides a rigid base container 110 with one or more modules 120. Next, interchangeable plant node container 200 may be inserted into module 120 to allow further allow irrigation with an internal irrigation system, as shown in subprocess 420 and subprocess 430. In subprocess 440, process 400 comprises controlling the water feed with a two-position control knob. However, controlling the water feed may comprise any other means to achieve this purpose.

In subprocess 440, the water feed is controlled depending on whether rigid base unit 110 of modular potting system 100 is hanging position or resting on a surface. For example, as shown in subprocess 450, if rigid base unit 110 of modular potting system 100 is hanging, then the water feed will open in drip main line 130 and close water feed in base drip emitter tube 145, as seen in subprocess 456 and subprocess 464. Conversely, if rigid base unit 110 of modular potting system 100 is resting on a surface as shown in 460, the water feed will open in base drip emitter tube 145 and close water feed in drip main line 130, as seen in subprocess 466 and subprocess 454.

Although FIG. 4 shows example blocks of modular potting method process 400, in some implementations, modular potting method process 400 may include additional blocks, fewer blocks, different blocks, or differently arranged blocks than those depicted in FIG. 4. Additionally, or alternatively, two or more of the blocks of modular potting method process 400 may be performed in parallel.

### INDUSTRIAL APPLICABILITY

Typically, non-automated irrigation systems demand manual labor for operation, making them labor-intensive and physically demanding, especially in gardening operations. On the other hand, automated electrical energy-requiring irrigation systems may require to operate in remote locations, such as small crop field locations, where no supporting infrastructure exists.

Accordingly, a modular potting system 100, which is capable is working with mechanical, hydraulic, gravity, or electrical energy, may offer a variety of benefits. Modular potting system 100 receives liquid through inlet flow that enters through base water inlet 140 or upper water inlet 160. Modular potting system 100 is designed to optimize the watering of plants, crops, or landscapes mitigating the need of constantly irrigate the inner parts of a modular planting system as in other systems. Modular potting system 100 comprises a network of components connected and dependent on the environmental factors such as temperature, humidity, wind, and solar radiation. These components allow to adequate modular potting system 100 depending on the needs of each plant and environment. modular potting system 100 minimizes water wastage, promotes healthier plant growth, and conserves resources, making it an environmentally responsible solution for maintaining lush and thriving green spaces with reduced space. Further, modular potting system 100 supports and enhances the growth of plant nodes, often used in hydroponic or aeroponic systems.

Other benefits of modular potting system 100 include that pots may be hung or rest on the ground, connect to each other with simple and concealable tubing, and the provide internal watering system to all plants in modular potting system 100 to get water and nutrients. Furthermore, modular potting system 100 accommodates the two or more stages of typical gardening: seed starting and planting. Module 120 is larger than most seed starters, giving roots room to grow. Additionally, when it's time to move the young plant to pot into modular potting system 100, the whole module 120 is plugged into modular potting system 100. Dirt may be added, then module 120 opened, avoiding root damage. As pots are interconnected, there is no limit to the number of plants and, as water flows to the next pot no matter how many are connected, there is no additional effort when adding more pots. These are examples of modular potting system's 100 benefits. However, it should be understood that the applications are not limited by these examples.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments may be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of gardening or industrial context or with a particular type of modular potting system and/or method. Hence, although the present embodiments are, for convenience of explanation, depicted and described as being implemented with modular potting systems, it will be appreciated that it can be implemented for various other types of modular potting systems, and in various other environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A modular potting system, comprising:
a rigid base unit with one or more modules;
at least one interchangeable plant node container configured to fit in the module, the interchangeable plant node container having
an iris control lever, and
a locking ring configured to secure the interchangeable plant node container to the module; and
an internal irrigation system having
a spiral drip emitter tube positioned throughout the rigid base unit configured to irrigate the interchangeable plant node container,
an upper water inlet configured to feed water to the spiral drip emitter tube,
a base drip emitter tube positioned at the base of the rigid base unit configured to irrigate the interchangeable plant node container,
a base water inlet configured to feed water to the base drip emitter tube, and
at least a water outlet configured to allow a controlled release of water,
wherein the spiral drip emitter tube and the base drip emitter tube are connected to the water outlet.

2. The system of claim 1, further comprising a two-position control knob in each water inlet and the water outlet, the two-position control knob configured to control a water feed into the internal irrigation system.

3. The system of claim 1, further comprising a detachable hook configured to support a weight of the modular potting system when hanging from the detachable hook.

4. The system of claim 2, wherein the control knob of the upper water inlet remains open, and the control knob of the base water inlet remains closed when the modular potting system is in a hanging configuration.

5. The system of claim 2, wherein the control knob of the base water inlet remains open, and the control knob of the upper water inlet remains closed when the modular potting system is resting on a surface.

6. The system of claim 1, further comprising a rigid sprinkler base.

7. The system of claim 1, wherein the water outlet is configured to be daisy-chained to another modular potting system.

8. The system of claim 1, wherein the interchangeable plant node container further comprises:
a slat configured to facilitate water drainage;
a lower iris control lever; and
a lower iris opening configured to allow plant growth.

9. The system of claim 1, wherein the rigid base unit is made of a material configured to contain potting soil.

10. An irrigation system for pot modules, the irrigation system comprising:
one or more modular potting system configured to be daisy-chained to each other, the modular potting system having
a rigid base unit configured to contain one or more pot modules,
at least one interchangeable plant node container configured to fit in the pot modules, the interchangeable plant node container including
an iris control lever, and
a locking ring configured to secure the interchangeable plant node container to the pot module;
a spiral drip emitter tube positioned throughout the rigid base unit configured to irrigate the interchangeable plant node containers;
an upper water inlet configured to feed water to the spiral drip emitter tube;
a base drip emitter tube positioned at the base of the rigid base unit configured to irrigate the interchangeable plant node containers;
a base water inlet configured to feed water to the base drip emitter tube; and
at least a water outlet configured to allow a controlled release of water,
wherein the spiral drip emitter tube and the base drip emitter tube are connected.

11. The system of claim 10, further comprising a two-position control knob in each water inlet and the water outlet, the two-position control knob configured to control a water feed into the internal irrigation system.

12. The system of claim 10, further comprising a detachable hook configured to support a weight of the modular potting system when hanging from the detachable hook.

13. The system of claim 10, further comprising a rigid sprinkler base.

14. The system of claim 11, wherein the control knob of the upper water inlet remains open, and the control knob of the base water inlet remains closed when the modular potting system is in a hanging configuration.

15. The system of claim 11, wherein the control knob of the base water inlet remains open, and the control knob of the upper water inlet remains closed when the modular potting system is resting on a surface.

16. The system of claim 10, wherein the interchangeable plant node container further
comprises:
a slat configured to facilitate water drainage;
a lower iris control lever; and
a lower iris opening configured to allow plant growth.

17. A modular potting method, the method comprising:
providing a rigid base unit having one or more modules;
inserting at least one interchangeable plant node container into the module, the interchangeable plant node container comprising
an iris control lever, and
a locking ring configured to secure the interchangeable plant node container to the module; and
irrigating the interchangeable plant node container with an internal irrigation system, the internal irrigation system comprising
a spiral drip emitter tube positioned throughout the rigid base unit,
an upper water inlet configured to feed water to the spiral drip emitter tube,
a base drip emitter tube positioned at the base of the rigid base unit,
a base water inlet configured to feed water to the base drip emitter tube, and
at least a water outlet configured to allow a controlled release of water,
wherein the spiral drip emitter tube and the base drip emitter tube are connected to the water outlet.

18. The method of claim 17, further controlling the water feed into the internal irrigation system through a two-position control knob in each water inlet and the water outlet.

19. The method of claim 18, further opening the control knob of the upper water inlet and closing the control knob of the base water inlet when the rigid base unit is in a hanging configuration.

20. The method of claim 18, further opening the control knob of the base water inlet and closing the control knob of the upper water inlet when the rigid base unit is resting on a surface.
